(19) United States
(12) Patent Application Publication
(10) Pub. No.: US 2025/0073113 A1
(43) Pub. Date: Mar. 6, 2025

(54) Multifunctional Face Massaging Device

(71) Applicant: Justin Robert Pryor, Moose Jaw (CA)

(72) Inventor: Justin Robert Pryor, Moose Jaw (CA)

(21) Appl. No.: 18/457,733

(22) Filed: Aug. 29, 2023

(51) Int. Cl. A61H 7/00; A45D 27/02; A45D 44/00

(52) U.S. Cl. CPC A61H 7/003; A45D 27/02; A45D 44/00; A61H 2201/1635; A61H 2201/1645; A61H 2201/169; A61H 2205/022

(57) ABSTRACT

The multifunctional shaving device is intended to provide users with a device that is portable, compact, and can assist in both face massages and shaving. Accordingly, one flexible end of the device may be used for placing shaving gel and applying the shaving cream evenly and comfortably on areas that require shaving. An opposing end of the same device has a slightly hardened surface and different shape that helps in massaging the face and head. The device further includes a plurality of divots that act as handles for handling the device in multiple ways. Further, the compact size and unique shape makes the device convenient to travel with. Additionally, the unique design and material of the device enables rinsing off shaving cream easily form the device. Thus, the device is an efficient and user-friendly toiletry tool that may be used by both men and woman.

### FIELD OF THE INVENTION

This invention relates generally to a face massage tool. More particularly, the present invention relates to a multifunctional face massaging tool that may also function as a shaving gel applicator.

### BACKGROUND OF THE INVENTION

Studies have shown that facial massage is effective in many ways. Some benefits of facial massage include improving circulation, relaxing muscles, and moving away cellular waste. Further, massage improves the appearance of your skin by reducing the appearance of fine lines and wrinkles. Face massagers come in all different types. There are tools built for sculpting and cleansing, while other ones vibrate and use microcurrents to help stimulate the skin. However, a face massaging tool that can assist both in shaving and facial massages is a rare find in the current market.

An objective of the present invention is to provide users with a device that is portable, compact, and can assist in both face massages and shaving. According to the present invention, one flexible end of the device may be used for placing a shaving gel and applying the shaving cream/gel evenly and comfortably on areas that require shaving. An opposing end of the same device has a slightly hardened surface and different shape that helps in massaging the face and head. Further, the present invention may be used by men and woman and is great for home use. Furthermore, the compact size and unique shape of the present invention makes the device convenient to travel with. Additionally, the unique design and material of the present invention enables rinsing off shaving cream easily form the device, making the device ideal and efficient for daily use.

### SUMMARY OF THE INVENTION

The multifunctional shaving device is intended to provide users with a device that is portable, compact, and can assist in both face massages and shaving. According to the present invention, one flexible end of the device may be used for placing a shaving gel and applying the shaving cream evenly and comfortably on areas that require shaving. An opposing end of the same device has a slightly hardened surface and different shape that helps in massaging the face and head. The device further comprises a plurality of divots that act as handles for handling the device in multiple ways. The present invention may be used by both men and woman and is great for home use. Further, the compact size and unique shape of the present invention makes the device convenient to travel with. Additionally, the unique design and material of the present invention enables rinsing off shaving cream easily form the device, making the device ideal and efficient for daily use.

### BRIEF DESCRIPTION OF THE DRAWINGS

FIG. 1 is a top-front-left perspective view of the present invention.

FIG. 2 is a bottom-rear-right perspective view of the present invention.

FIG. 3 is a bottom-front-left perspective view of the present invention.

FIG. 4 is a top plan view of the present invention.

FIG. 5 is a bottom plan view of the present invention.

FIG. 6 is a front elevational view of the present invention.

FIG. 7 is a rear elevational view of the present invention.

FIG. 8 is a right-side elevational view of the present invention.

FIG. 9 is a left side elevational view of the present invention.

### DETAIL DESCRIPTIONS OF THE INVENTION

All illustrations of the drawings are for the purpose of describing selected versions of the present invention and are not intended to limit the scope of the present invention.

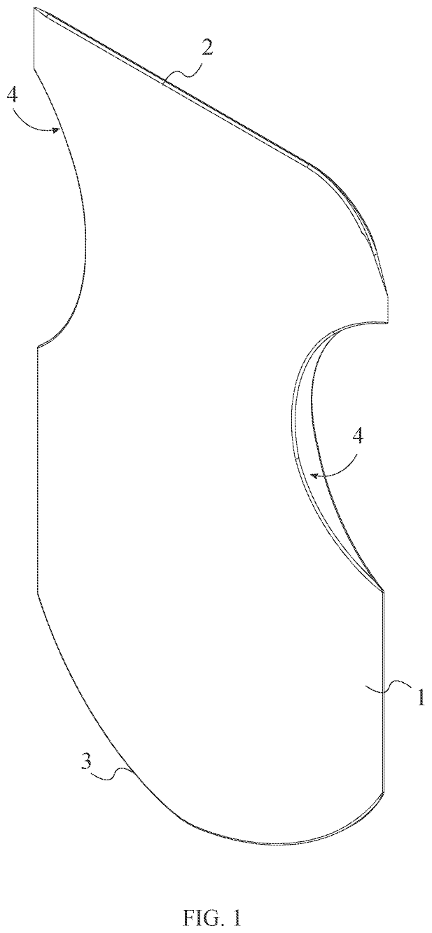

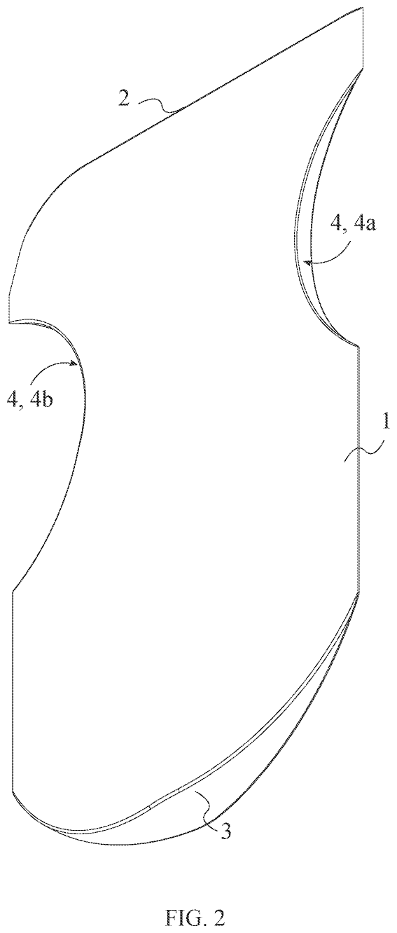

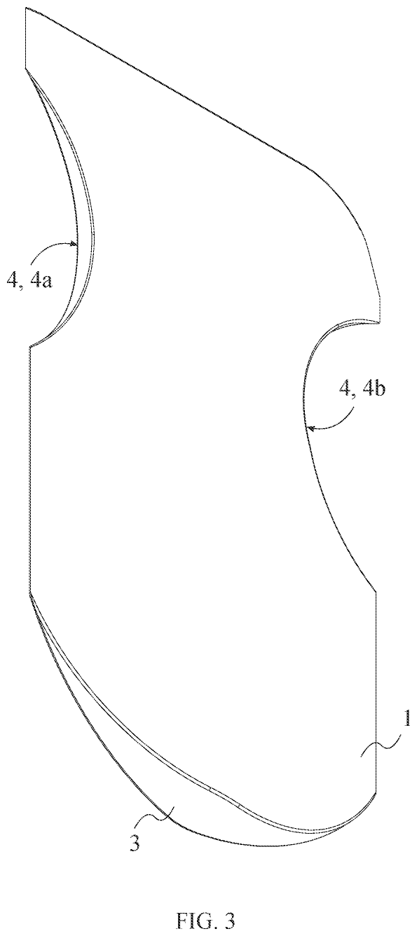

In reference to FIG. 1 through FIG. 9, the present invention is a multifunctional face massage device. It is an objective of the present invention to provide users with a device that is portable, compact, and can assist in both face massages and shaving.

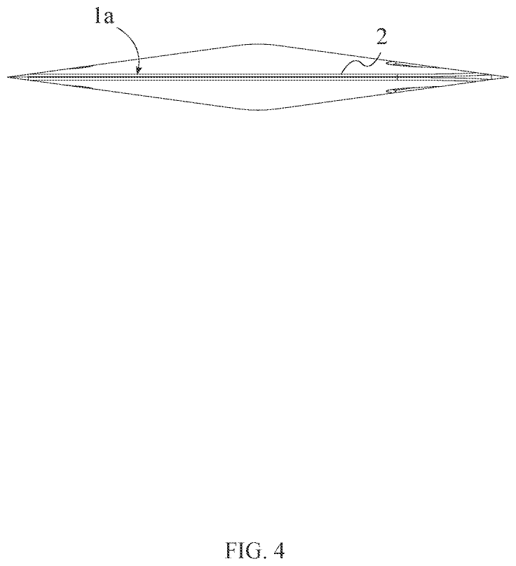

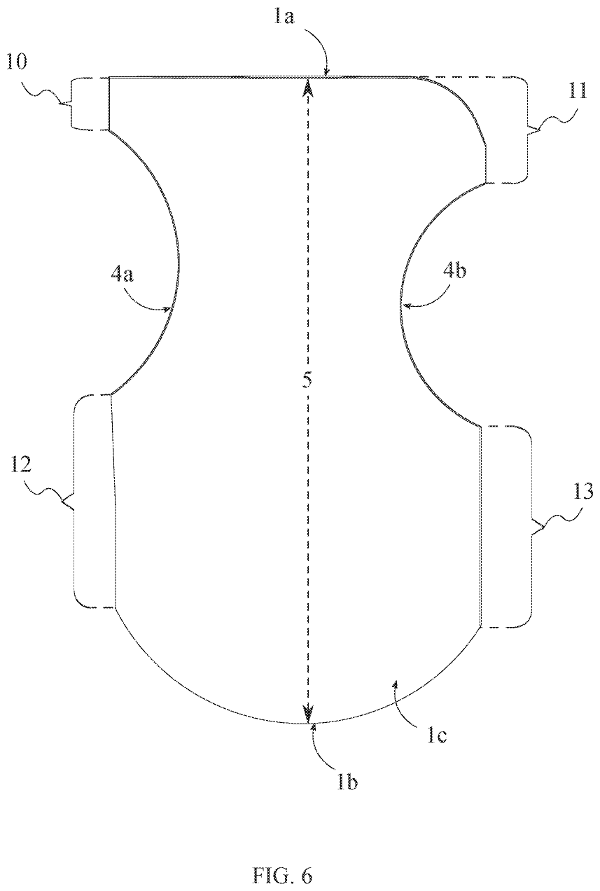

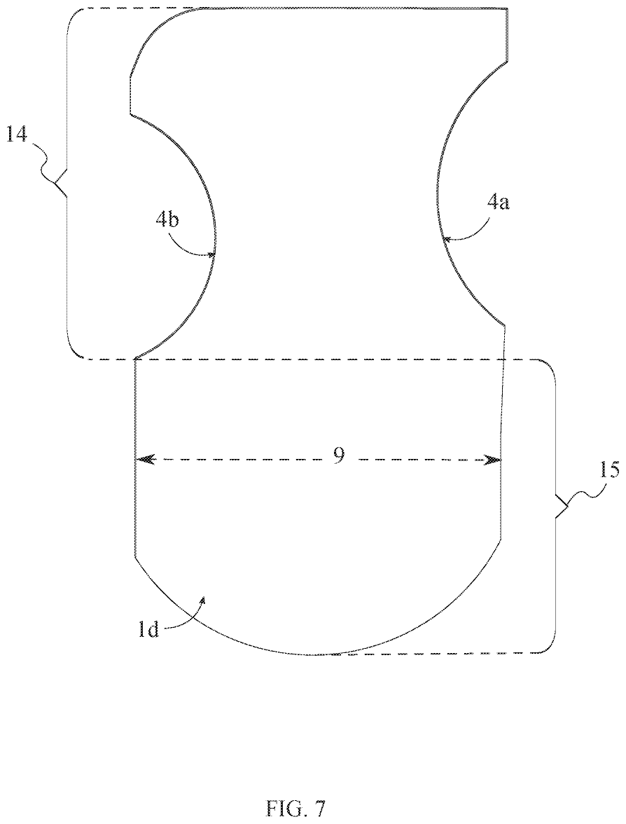

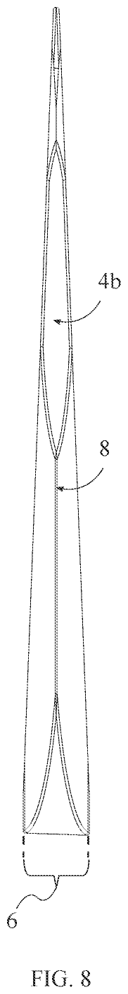

The following description is in reference to FIG. 1 through FIG. 9. According to a preferred embodiment, the present invention comprises a body 1, a thin head 2, a rounded tail 3, and a plurality of indents 4. The body constitutes the overall structure of the present invention that may be used for multiple functionalities. Preferably, the body 1 is made of a flexible yet hard material that has a smooth exterior, such as silicone. However, the body 1 may comprise any other material or a combination of materials that are known to one of ordinary skill in the art, as long as the objectives of the present invention are not altered. In the preferred embodiment, the body 1 comprises a first end 1a and a second end 1b wherein the first end 1a is positioned opposite to the second end 1b across a length 5 of the body 1. As seen in FIG. 6, the first end 1a constitutes a top end of the body 1, and the second end 1b constitutes a bottom end of the body 1. As seen in FIG. 1, and FIG. 4, the thin head 2 extends along the first end 1a. More specifically, the thin head 2 is the top part of the present invention that helps with shaving gel application. Further, the rounded tail 3 is positioned along the second end 1b of the body 1. Preferably, the rounded tail 3 constitutes the bottom end of the body 1 and this region helps with massaging different points of the face and head. Furthermore, the body 1 comprises a first surface 1c and a second surface 1d, wherein the first surface 1c is positioned opposite to the second surface 1d across a thickness 6 of the body 1. In other words, the first surface 1c and the second surface 1d constitute a front surface and a back surface respectively, of the body 1. As seen in FIG. 8, the thickness 6 of the body tapers as it extends from the second end 1b towards the first end 1a. This is so that the thinner top portion of the body 1 may be used for shaving applications, and the thicker multidimensional bottom portion may be used for massaging purposes. Furthermore, the plurality of indents 4 is laterally integrated between the first surface 1c and the second surface 1d. In the preferred embodiment, the plurality of indents 4 is intended to provide grip as well as help with massaging specific areas of the face such as nose, under the chin, etc. As seen in FIG. 1 through FIG. 7, the plurality of indents 4 traverse into the body 1 from opposing sides of the body 1. As seen in FIG. 6 and FIG. 7, the plurality of indents 4 are curved recessions. However, the plurality of indents 4 may comprise any other size, shape, radii, orientation, location, etc., as long as the objectives of the present invention are fulfilled.

A more detailed description of the present invention follows.

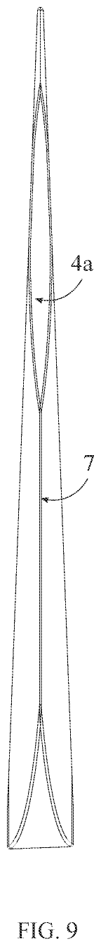

It is an aim of the present invention to enable easy and safe handling of the device during both massaging and shaving processes. To that end, the plurality of indents 4 acts as ergonomic handles. In the preferred embodiment, the plurality of indents is concave in shape and the plurality of indents 4 comprises a first indent 4a and a second indent 4b. Preferably, the first intent 4a is integrated along a first lateral surface 7 of the body 1, and the second intent 4b is integrated along a second lateral surface 8 of the body 1, wherein the first lateral surface 7 is positioned opposite to the second lateral surface 8 across a width 9 of the body 1. In other words, the first lateral surface 7 and the second lateral surface 8 constitute two side surfaces of the present invention. Further, as seen in FIG. 6 and FIG. 7, the second indent 4b extends deeper into the body 1 than the first indent 4a. The difference in radius of curvature of the first indent 4a and second indent 4b is so that the user could have a stronger hold at certain points as well as the differently shaped curves may provide efficient massage for different profiles on the face, such as chin, nose edge, etc. Furthermore, as seen in FIG. 8, and FIG. 9, a transverse cross section of the first lateral surface 7 and the second lateral surface 8 is wedge shaped. This is because, the thickness 6 of the body 1 increases as the body 1 extends from the first end 1a towards the second end 1b, giving the device a wedge shape along the opposing sides.

Continuing with the preferred embodiment, the present invention comprises a first section 10, a second section 11, a third section 12, and a fourth section 13. Preferably, the first section 10 is positioned between the first end 1a and the first indent 4a, the second section 11 is positioned between the first end 1a and the second indent 4b, the third section 12 is positioned between the second end 1b and the first indent 4a, and the fourth section 13 is positioned between the second end 1b and the second indent 4b. As seen in FIG. 6, the first section 10, the third section 12, and the fourth section 13 are linear segments that are positioned normally to the thin head 2. In other words, the first section 10, the third section 12, and the fourth section 13 are straight edges of the body 1 that are parallel to each other and perpendicular to the thin head 2. Further, the second section 11 extends seamlessly from the thin head 2 towards the second indent 4b, wherein the second section 11 is arched between the thin head 2 and the second indent 4b. In other words, the second section 11 is an arc that is positioned between the thin head 2 and the second indent 4b. This rounded edge helps with providing a softer massage along sensitive and curved areas of the face.

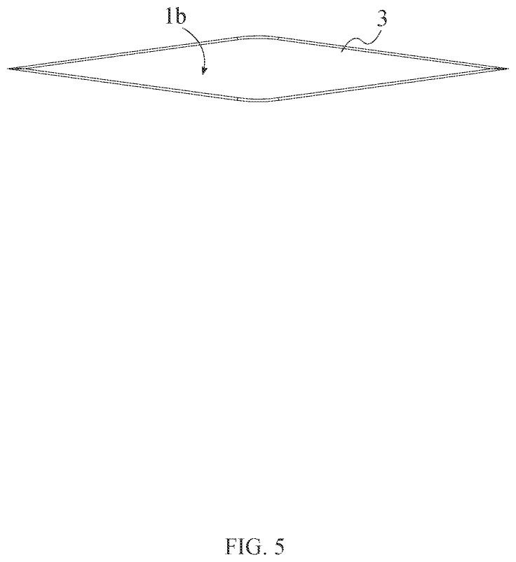

As seen in FIG. 5, the second end 1b is rhomboidal in shape. In other words, the bottom surface of the present invention has the shape of a rhombus. This specific shape helps in massaging parts of the forehead and other parts of the head and face in an efficient manner. To that end, perimetrical edges of the second end 1b are made blunt. Further, the rounded tail 3 is arched in shape. In other words, the bottom end of the body has an arch shape or is semi circular in shape. This slightly thicker and rounded end of the body 1 helps with massaging along a user's head and/or face.

In reference to FIG. 7, the present invention comprises a first region 14 and a second region 15, wherein the first region 14 is positioned adjacent to the first end 1a, the second region 15 is positioned adjacent to the second end 1b, and the first region 14 and the second region 15 are connected seamlessly along the length 5 of the body. Preferably, the first region 14 is used as a shaving gel applicator, and the second region 15 is used as a face massager. To that end, the first region 14 is flexible and thinner, and the second region 15 is flatter and harder than the first region 14. However, it should be noted that any part of the body 1 of the present invention may be used for face massaging and/or shaving gel application according to the user's preference.

Although the invention has been explained in relation to its preferred embodiment, it is to be understood that many other possible modifications and variations can be made without departing from the spirit and scope of the invention as hereinafter claimed.

What is claimed is:

1. A multifunctional face massaging device comprising:
a body;
a thin head;
a rounded tail;
a plurality of indents;
the body comprising a first end and a second end wherein the first end is positioned opposite to the second end across a length of the body;
the thin head extending along the first end;
the rounded tail being positioned along the second end;
the body comprising a first surface and a second surface, wherein the first surface is positioned opposite to the second surface across a thickness of the body;
the thickness of the body tapering as it extends from the second end towards the first end;
the plurality of indents traversing into the body; and
the plurality of indents being laterally integrated between the first surface and the second surface.

2. The multifunctional face massaging device of claim 1, comprising:
the plurality of indents comprising a first indent and a second indent;
the first intent being integrated along a first lateral surface of the body;
the second intent being integrated along a second lateral surface of the body; and
the first lateral surface being positioned opposite to the second lateral surface across a width of the body.

3. The multifunctional face massaging device of claim 2, wherein a transverse cross section of the first lateral surface and the second lateral surface is wedge shaped.

4. The multifunctional face massaging device of claim 2, wherein the second indent is deeper than the first indent.

5. The multifunctional face massaging device of claim 2, comprising:
a first section, a second section, a third section, and a fourth section;
the first section being positioned between the first end and the first indent;
the second section being positioned between the first end and the second indent;
the third section being positioned between the second end and the first indent;
the fourth section being positioned between the second end and the second indent;
the first section, the third section, and the fourth section being linear segments that are positioned normal to the thin head;
the second section extending seamlessly from the thin head towards the second indent; and
the second section being arched between the thin head and the second indent.

6. The multifunctional face massaging device of claim 1, wherein the bottom end is rhomboidal in shape.

7. The multifunctional face massaging device of claim 1, wherein the rounded tail is arched in shape.

8. The multifunctional face massaging device of claim 1, comprising:
a first region and a second region;
the first region being positioned adjacent to the first end;
the second region being positioned adjacent to the second end; and
the first region and the second region being connected seamlessly along the length of the body.

9. The multifunctional face massaging device of claim 8, wherein the second region is used as a face massager.

10. The multifunctional face massaging device of claim 8, wherein the first region is used as a shaving gel applicator.

11. The multifunctional face massaging device of claim 8, wherein the first region is flexible.

12. The multifunctional face massaging device of claim 1, wherein the body is made of silicone.

13. The multifunctional face massaging device of claim 1, wherein the rounded tail is harder than the thin head.

14. The multifunctional face massaging device of claim 1, wherein the plurality of indents is concave in shape.

15. The multifunctional face massaging device of claim 1, wherein plurality of indents is ergonomic handles.

16. The multifunctional face massaging device of claim 1, wherein perimetrical edges of the second end are blunt.

17. A multifunctional face massaging device comprising:
a body;
a thin head;
a rounded tail;
a plurality of indents;
the body comprising a first end and a second end wherein the first end is positioned opposite to the second end across a length of the body;
the plurality of indents comprising a first indent and a second indent;
the thin head extending along the first end;
the rounded tail being positioned along the second end;
the body comprising a first surface and a second surface, wherein the first surface is positioned opposite to the second surface across a thickness of the body;
the thickness of the body tapering as it extends from the second end towards the first end;
the plurality of indents traversing into the body;
the plurality of indents being laterally integrated between the first surface and the second surface;
the first intent being integrated along a first lateral surface of the body;
the second intent being integrated along a second lateral surface of the body; and
the first lateral surface being positioned opposite to the second lateral surface across a width of the body.

18. The multifunctional face massaging device of claim 17, comprising:
a first section, a second section, a third section, and a fourth section;
the first section being positioned between the first end and the first indent;
the second section being positioned between the first end and the second indent;
the third section being positioned between the second end and the first indent;
the fourth section being positioned between the second end and the second indent;
the first section, the third section, and the fourth section being linear segments that are positioned normal to the thin head;
the second section extending seamlessly from the thin head towards the second indent; and
the second section being arced between the thin head and the second indent.

19. The multifunctional face massaging device of claim 1, comprising:
a first region and a second region;
the first region being positioned adjacent to the first end, wherein the first region is used as a shaving gel applicator;
the second region being positioned adjacent to the second end, wherein the second region is used as a face massager; and
the first region and the second region being connected seamlessly along the length of the body.

20. The multifunctional face massaging device of claim 19, comprising:
wherein the first region is flexible;
wherein the second region is harder than the first region.
